(19) United States
(12) Patent Application Publication
(10) Pub. No.: US 2012/0023708 A1
(43) Pub. Date: Feb. 2, 2012

(54) Fastener Device for Boutonnieres and Corsages

(76) Inventor: Stephanie E. Crilly, Hatboro, PA (US)

(21) Appl. No.: 12/846,138

(22) Filed: Jul. 29, 2010

(51) Int. Cl. A44C 25/00; B23P 11/00

(52) U.S. Cl. 24/5; 29/525.05

(57) ABSTRACT

A fastener device facilitating the secured attachment of a boutonniere or corsage to an article of clothing is described. The fastener device includes a heat shrinkable tube and at least one fastener assembly. The heat shrinkable tube is sliable along a stem extending from a flower arrangement prior to the application of heat and fixable to the stem after heat has been applied. Each fastener assembly is disposed along and extends from the heat shrinkable tube. One or more such fasteners secure the fastener device to an article of clothing, thus securing a flower arrangement to an article of clothing.

### CROSS REFERENCE TO RELATED APPLICATIONS

None.

### FEDERALLY SPONSORED RESEARCH AND DEVELOPMENT

None.

### BACKGROUND OF THE INVENTION

1. Field of the Invention

The invention generally relates to a fastener facilitating the secure attachment of flowers to an article of clothing. Specifically, the invention includes a heat shrinkable tube which enables attachment of one or more fasteners onto the stem of a boutonniere or corsage, thus allowing the flower arrangement to be properly secured to a lapel along a jacket or a dress.

2. Background

Formal occasions often include the purchase of flowers in the form of a boutonniere or corsage attachable to an article of clothing. Most boutonnieres and corsages are sold with one or more long straight pins which require great skill and patience to properly attach a flower arrangement onto a jacket or dress. More often than not, the boutonniere or corsage is secured to a jacket or dress in a less than secure manner, thus allowing the flower arrangement to flop around on or fall off of an article of clothing.

While the related arts include a variety of mechanical holders and fasteners for boutonnieres and/or corsages, the secure attachment of flower arrangements to clothing remains a significant challenge and source of great embarrassment particularly in the context of proms and formals.

As is readily apparent from the discussions above, the related arts do not include a device which facilitates quick and secure attachment of a boutonniere or corsage to an article of clothing.

Therefore, what is required is a device which facilitates the secure attachment of a boutonniere or corsage to an article of clothing while minimizing the skill to do so.

### SUMMARY OF THE INVENTION

An object of the invention is to provide a device which facilitates the secure attachment of a boutonniere or corsage to an article of clothing while minimizing the skill to do so.

The fastener device includes a heat shrinkable tube and at least one fastener assembly. The heat shrinkable tube is sliable along a stem extending from a flower arrangement prior to the application of heat and fixable to the stem after heating. Each fastener assembly is disposed along and extends from the heat shrinkable tube. One or more fasteners are capable of securing the fastener device with flower arrangement to an article of clothing.

In other embodiments, the fastener device could mechanically secure at least one fastener assembly between the heat shrinkable tube and stem after the tube is shrunk onto the stem.

In other embodiments, the fastener assembly could be secured to the heat shrinkable tube via an adhesive.

In other embodiments, the fastener assembly could include a post and a clasp, wherein the post could further include a base attached to a pin in a nearly perpendicular arrangement.

In other embodiments, the base could be disposed between the heat shrinkable tube and the stem so that the pin passes through the heat shrinkable tube and extends therefrom.

In other embodiments, the length of the heat shrinkable tube could be less than the length of the stem.

The described invention provides advantages over the related arts. The invention avoids the use of straight pins and other difficult to use fasteners otherwise required to pass through a boutonniere or corsage and clothing for proper attachment of a flower arrangement to a jacket, dress, or other article of clothing. The contractible nature of the heat shrinkable tube accommodates a variety of cross sectional sizes and shapes typical of boutonnieres and corsages. The heat shrinkable tube is readily activated via a hair dryer, heat gun, heating iron, hot liquid, and other heat producing means and devices available to the florist profession and purchasers of flower products.

The above and other objectives, features, and advantages of the preferred embodiments of the invention will become apparent from the following description read in connection with the accompanying drawings, in which like referenced numerals designate the same or similar elements.

REFERENCE NUMERALS

| | |
|---|---|
| 1 | Boutonniere |
| 2 | Flower |
| 3 | Stem |
| 4 | Lapel |
| 5 | Fastener device |
| 6 | Fastener assembly |
| 7 | Heat shrinkable tube |
| 8 | Post |
| 9 | Pin |
| 10 | Clasp |
| 11 | Adhesive |
| 12 | Heat |
| 13 | Base |

### BRIEF DESCRIPTION OF THE INVENTION

Additional aspects, features, and advantages of the invention will be understood and will become more readily apparent when the invention is considered in the light of the following description made in conjunction with the accompanying drawings.

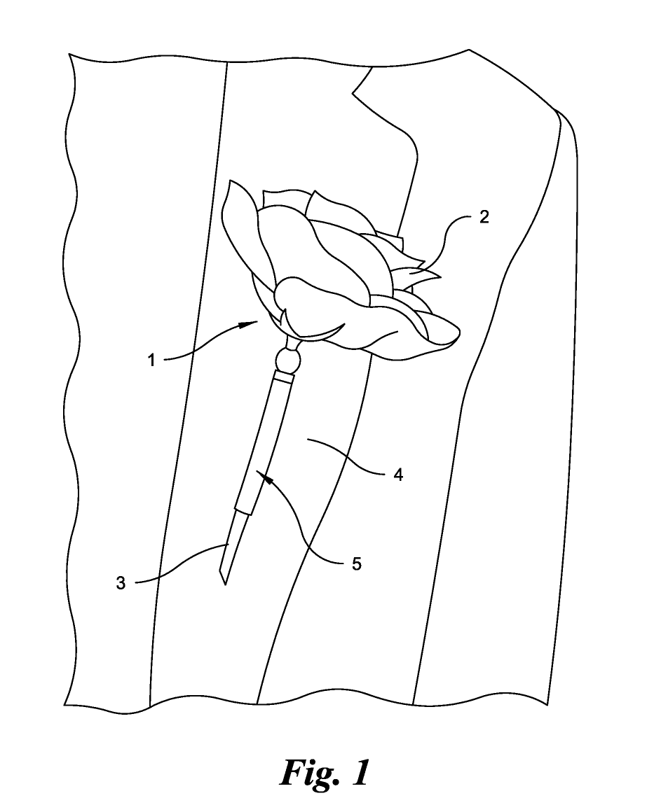

FIG. 1 is a perspective view illustrating attachment of a fastener device along the stem of a flower comprising a boutonniere and further to the lapel of a jacket in accordance with one embodiment of the invention.

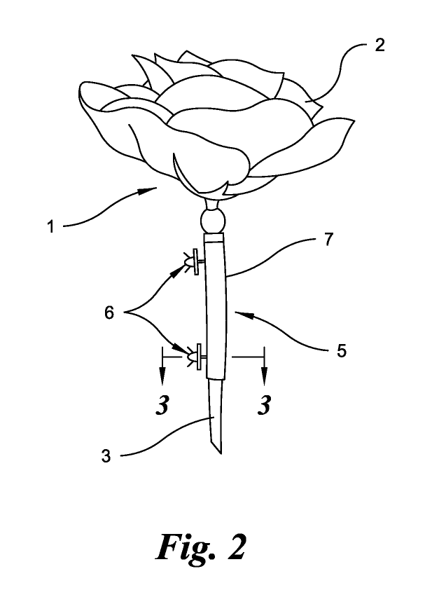

FIG. 2 is a side view illustrating arrangement of a fastener device along the stem of a boutonniere with two fastener assemblies secured to the stem via a heat shrinkable tube so that the fastener assemblies extend from the fastener device in accordance with one embodiment of the invention.

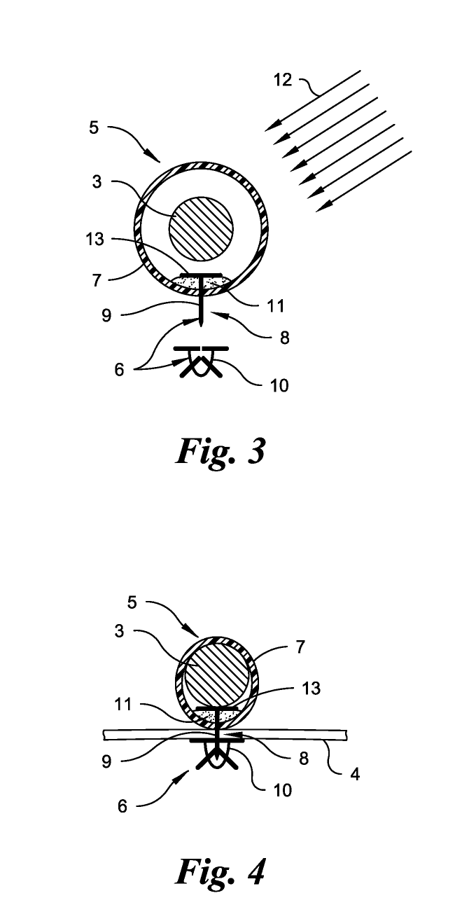

FIG. 3 is a cross section view illustrating arrangement of the fastener device about the stem along the boutonniere in FIG. 2 with fastener assembly disposed along one side of the stem and projecting outward from a heat shrinkable tube prior to application of heat onto the tube in accordance with one embodiment of the invention.

FIG. 4 is a cross section view illustrating the fastener device in FIG. 3 after heat is applied to shrink the heat shrinkable tube thereby securing the tube and fastener to the stem of the boutonniere in accordance with an embodiment of the invention.

### DETAILED DESCRIPTION OF THE INVENTION

Reference will now be made in detail to several preferred embodiments of the invention that are illustrated in the accompanying drawings. Wherever possible, same or similar reference numerals are used in the drawings and the description to refer to the same or like parts or steps. The drawings are in simplified form and are not to precise scale.

While the invention is described with particular reference to boutonnieres, it is understood that the invention is likewise applicable to other flower arrangements worn on an article of clothing including, but not limited to, corsages. Flower arrangements could include one or more flowers and related accessories.

Clothing is further understood to broadly include items directly or indirectly contacting a body including, but not limited to, jackets, shirts, dresses, pants, footwear, bags, towels, and hats.

Referring now to FIG. 1, the fastener device 5 is shown disposed along and fixed onto the stem 3 opposite of a flower 2 in the form of a boutonniere 1. The fastener device 5 is generally defined as a sleeve that surrounds and conforms to the shape of the stem 3 after it is shrunk onto the stem 3. The fastener device 5 is further secured to a lapel 4 disposed along a jacket or other clothing.

Referring now to FIG. 2, the fastener device 5 is shown with a pair of fastener assemblies 6 secured to the stem 3. It is understood that the invention could include one or more such fastener assemblies 6. The fastener assemblies 6 may include a variety of devices known within the art that allow for attachment of a boutonniere 1 to an article of clothing. For example, the fastener assemblies 6 could include one-piece elements, one non-limiting example being a safety pin, or two-piece elements, one non-limiting example being a post-clasp system. Fastener assemblies 6 are preferred to be generally disposed along and extend from the fastener device 5 along the side of the boutonniere 1 nearest to the surface onto which it is attached. Fastener assemblies 6 could be arranged along a single linear row or disposed in an offsetting or random pattern.

Referring now to FIG. 3, an exemplary fastener device 5 is shown disposed about a stem 3. The fastener device 5 includes a heat shrinkable tube 7 which is sufficiently large so as to allow the fastener device 5 to fit over and thereby slidable along the stem 3. A two-piece fastener assembly 6 is shown including a post 8 and a clasp 10. The post 8 could further include a base 13 attached to a pin 9 in a substantially perpendicular arrangement. The pin 9 passes through the wall of the heat shrinkable tube 7 so that it extends therefrom. The pin 9 should be sufficiently long so as to traverse the thickness of the item onto which it is attached and allow for attachment of a clasp 10 or the like. The base 13 could reside within the opening along the heat shrinkable tube 7. This arrangement allows limited movement of the post 8 with respect to the heat shrinkable tube 7. The dimensions of the base 13 are design dependent; however, it is preferred for the base 13 to be sufficiently small so as to avoid damage to the heat shrinkable tube 7 as it contracts about the stem 3. In preferred embodiments, the base 13 could be rectangular shaped with its major axis aligned substantially along the length of the stem 3. In some embodiments, the post 8 could be secured to the heat shrinkable tube 7 in a fixed arrangement via an adhesive 11 disposed between the base 13 and heat shrinkable tube 7.

The heat shrinkable tube 7 could be composed of a material, preferably a flexible composition, which contracts or shrinks when exposed to a heat source that elevates the temperature of the tube to an activation temperature. For example, the heat shrinkable tube 7 could be a wire wrap device used by electricians and other trades to bundle and secure wires. The length of the heat shrinkable tube 7 could be longer or shorter than the length of the stem 3.

In some embodiments, the heat shrinkable tube 7 could include one or more colors which compliment colors in the flower arrangement and/or clothing or match the color of the stem 3 so as to conceal the fastener device 5. In yet other embodiments, the heat shrinkable tube 7 could include decorative designs or ornamentation.

In some embodiments, the heat shrinkable tube 7 could be directly molded onto the fastener assemblies 6. In other embodiments, one or more fastener assemblies 6 could be assembled onto a heat shrinkable tube 7.

In one such example, a post 8 could be assembled onto one or both ends of a heat shrinkable tube 7. The pin 9 is angled with respect to the heat shrinkable tube 7 and inserted therein so as to contact and pierce the heat shrinkable tube 7 adjacent to the end. The pin 9 is then pressed through the wall of the heat shrinkable tube 7 and rotated so that the base 13 is then parallel to the wall. When a post 8 is required along the mid-section of the heat shrinkable tube 7, a small slot or opening could be made along a portion of the circumference of the heat shrinkable tube 7 and the post 8 inserted therein so that the pin 9 contacts and pierces the wall of the heat shrinkable tube 7. The pin 9 is then pressed through the wall until the base 13 contacts the interior surface of the heat shrinkable tube 7. A bead of adhesive 11 could be applied between the base 13 and interior surface of the heat shrinkable tube 7 so as to fix and secure the post 8 to the heat shrinkable tube 7.

After the heat shrinkable tube 7 is properly aligned along the stem 3, heat 12 is applied directly onto the fastener device 5, as represented in FIG. 3. Heat 12 could be applied via various means including, but not limited to, blowing hot air onto the heat shrinkable tube 7 via a hair dryer or heat gun, immersing the heat shrinkable tube 7 into a hot liquid, one non-limiting example being water, or contacting the heat shrinkable tube 7 with a heating element, one non-limiting example being a curling iron.

Referring now to FIG. 4, the fastener device 5 is shown after heat 12 has been applied to the heat shrinkable tube 7 causing it to shrink onto, contact, and conform to the general cross-sectional shape of a stem 3 in a fixed arrangement. At the very least, the heat shrinkable tube 7 should obtain a final diameter which resists further sliding of the fastener device 5 along the stem 3. In preferred embodiments, the heat shrinkable tube 7 should apply a compressive force onto at least a portion of the stem 3 contacted thereby. For example, a heat shrinkable tube 7 having an initial nominal diameter of 0.375-inches and a final nominal diameter of 0.1875-inches after heating was sufficient to secure a 1.5-inch long heat shrinkable tube 7 to a stem 3 with a nominal diameter of 0.25-inches.

In some embodiments, contraction of the heat shrinkable tube 7 onto the stem 3 could secure a fastener assembly 6 to the stem 3, as generally represented in FIG. 4. In these embodiments, the base 13 is mechanically secured between the heat shrinkable tube 7 and the stem 3. In preferred embodiments, the heat shrinkable tube 7 should apply a compressive force onto the stem 3 and base 13.

After the heat shrinkable tube 7 is shrunk onto and secured to the stem 3, the pin 9 is pressed into and through an article of clothing, as represented by the lapel 4 in FIG. 4. A clasp 10 is then placed onto the pin 9, thereby securing the fastener device 5 and boutonniere 1 held thereby to the article of clothing.

The fastener device 5 is attached to an article of clothing by first sliding the heat shrinkable tube 7 onto a stem 3 extending from one end of a flower arrangement. Heat 12 is then applied onto the fastener device 5 so as to elevate the temperature of the heat shrinkable tube 7 to at least the heat activation temperature at which the material begins to shrink or contract along its diameter or its diameter and length. Heat 12 is applied until such time when the heat shrinkable tube 7 has shrunk onto the stem 3 contacting at least a portion of the stem 3. Thereafter, the flower arrangement is attached to an article of clothing via one or more fastener assemblies 6 disposed along and attached to the fastener device 5. Fastener assemblies 6 may be fixed to or adjusted with respect to the heat shrinkable tube 7. In some embodiments, contraction of the heat shrinkable tube 7 onto the stem 3 could mechanically secure the fastener assembly 6 to the stem 3. In other embodiments, the heat shrinkable tube 7 could be adhesively bonded to each fastener assembly 6.

The description above indicates that a great degree of flexibility is offered in terms of the invention. Although the invention has been described in considerable detail with reference to certain preferred versions thereof, other versions are possible. Therefore, the spirit and scope of the appended claims should not be limited to the description of the preferred versions contained herein.

What is claimed is:

1. A fastener device for securing a flower arrangement onto an article of clothing comprising:
(a) a heat shrinkable tube sliable along a stem extending from said flower arrangement prior to the application of heat and fixable to said stem after the application of heat; and
(b) at least one fastener assembly disposed along and extending from said heat shrinkable tube, said at least one fastener capable of securing said fastener device with said flower arrangement to said article of clothing.

2. The fastener device claim 1, wherein said fastener device mechanically secures said as least one fastener assembly to said heat shrinkable tube and said stem after said heat shrinkable tube is shrunk onto said stem.

3. The fastener device of claim 1, wherein said at least one fastener assembly is secured to said heat shrinkable tube via an adhesive.

4. The fastener device of claim 1, wherein said at least one fastener assembly includes a post and a clasp.

5. The fastener device of claim 4, wherein said post includes a base attached to a pin in a nearly perpendicular arrangement.

6. The fastener device of claim 5, wherein said base is disposed between said heat shrinkable tube and said stem and said pin passes through said heat shrinkable tube and extends therefrom.

7. The tree slide of claim 1, wherein the length of said heat shrinkable tube is less than the length of said stem.

8. A method of securing a fastener device for use with an article of clothing onto a flower arrangement comprising the steps of:
(a) sliding a tube composed of heat shrinkable material onto a stem extending from said flower arrangement, said tube have at least one fastener assembly extending therefrom; and
(b) heating said tube so that said tube dimensionally shrinks so as to contact said stem fixing said tube to said stem.

9. The method of claim 8, wherein said heating step mechanically secures said at least one fastener assembly onto said stem.

10. The method of claim 8, wherein said heating step includes blowing hot air over said tube, immersing said tube into a hot liquid, or contacting said tube with a hot element.

11. The method of claim 8, further comprising the step of:
(c) gluing said at least on fastener assembly onto said tube.

12. The method of claim 8, further comprising the step of:
(c) securing said flower arrangement onto said article of clothing via said at least one fastener.

13. A method of securing a flower arrangement onto an article of clothing comprising the step of attaching said flower arrangement to said article of clothing via at least one fastener attached to and extending from a tube shrunk onto said flower arrangement via heat.

14. The method of claim 13, wherein said flower arrangement is a boutonniere or a corsage.

15. The method of claim 13, wherein said article of clothing is a shirt, jacket or dress.
